(19) United States
(12) Patent Application Publication
(10) Pub. No.: US 2025/0031030 A1
(43) Pub. Date: Jan. 23, 2025

(54) APPARATUS AND METHOD FOR INTELLIGENT MODEL AND FUNCTIONALITY MANAGEMENT CONSIDERING INFERENCE TIME IN WIRELESS COMMUNICATION SYSTEM

(71) Applicant: Electronics and Telecommunications Research Institute, Daejeon (KR)

(72) Inventors: Yong Jin KWON, Daejeon (KR); Seung Jae BAHNG, Daejeon (KR); An Seok LEE, Daejeon (KR); Hee Soo LEE, Daejeon (KR); Yun Joo KIM, Daejeon (KR); Hyun Seo PARK, Daejeon (KR); Jung Bo SON, Daejeon (KR); Yu Ro LEE, Daejeon (KR)

(21) Appl. No.: 18/777,467

(22) Filed: Jul. 18, 2024

(30) Foreign Application Priority Data
Jul. 19, 2023 (KR) 10-2023-0094121
Apr. 3, 2024 (KR) 10-2024-0045253
Jul. 15, 2024 (KR) 10-2024-0093113

(51) Int. Cl. H04W 8/24; H04L 27/26; H04W 76/10

(52) U.S. Cl. CPC H04W 8/24; H04L 27/26136; H04W 76/10

(57) ABSTRACT

Proposed is a wireless communication system and, in more detail, an apparatus and method for intelligent model and functionality management considering inference time in a wireless communication system. A method of operating user equipment (UE) for identifying and managing an intelligent functionalities or models in a wireless communication system, includes a process of receiving UE capability enquiry from a base station (BS), and a process of transmitting UE capability information to the base station, wherein the UE capability information includes inference time information, the base station identifies intelligent functionality and model that the user equipment can support, on the basis of the UE capability enquiry and the UE capability information, and performance of an intelligent model that the user equipment can perform is identified on the basis of the inference time information.

### CROSS REFERENCE TO RELATED APPLICATION

The present application claims priority to Korean Patent Applications No. 10-2023-0094121, filed Jul. 19, 2023, No. 10-2024-0045253, filed Apr. 3, 2024, No. 10-2024-0093113, filed Jul. 15, 2024, the entire contents of which are incorporated herein for all purposes by this reference.

### BACKGROUND

### Technical Field

The present disclosure generally relates to a wireless communication system and, in more detail, to an apparatus and method for intelligent (AI/ML) model and functionality management considering inference time in a wireless communication system.

### Description of the Related Art

An intelligent (AI/ML) technology application plan for an NR air interface is under discussion as a Study Item (SI) in Release 18 by 3GPP that is an international standardization association.

The purpose of the study item is to establish use cases where an intelligent technology in an NR air interface can be used and to determine performance gains accompanying use of an intelligent technology in each use case, etc. In detail, Channel State Information (CSI) Feedback Enhancement, Beam Management, Positioning Accuracy Enhancement, etc. have been selected as representative cases.

### SUMMARY

On the basis of the discussion described above, the present disclosure provides an apparatus and method for intelligent model and functionality management considering inference time in a wireless communication system.

Further, the present disclosure provides an apparatus and system for model identification and life cycle management process including inference time information for transmitting different inference time information to each user equipment in a wireless communication system.

Further, the present disclosure provides an apparatus and method for making a base station and use equipment share inference time information in the process in which intelligent functionality and model are identified in a wireless communication system.

Further, the present disclosure provides an apparatus and method for monitoring inference time information and managing a model in the process in which an intelligent model is operated in a wireless communication system.

According to various embodiments of the present disclosure, a method of operating user equipment (UE) for identifying and managing an intelligent functionality or model in a wireless communication system, includes: a process of receiving UE capability enquiry from a base station (BS); and a process of transmitting UE capability information to the base station, wherein the UE capability information includes inference time information, the base station identifies intelligent functionality and model that the user equipment can support, on the basis of the UE capability enquiry and the UE capability information, and performance of an intelligent model that the user equipment can perform is identified on the basis of the inference time information.

According to various embodiments of the present disclosure, a method of operating a base station (BS) for identifying and managing an intelligent functionality or model in a wireless communication system, includes: a process of transmitting UE capability enquiry to user equipment (UE); and a process of receiving UE capability information from the user equipment, wherein the UE capability information includes inference time information, the method includes: a process of identifying intelligent functionality and model that the user equipment can support, on the basis of the UE capability enquiry and the UE capability information; and a process of identifying performance of an intelligent model that the user equipment can perform, on the basis of the inference time information.

According to various embodiments of the present disclosure, a method of operating user equipment (UE) for managing an operation of intelligent model and functionality in a wireless communication system, includes: a process of computing minimum required inference time for operating the intelligent model and functionality; a process of transmitting the inference time to a base station (BS), wherein the inference time is represented by the number of orthogonal frequency division multiplexing (OFDM) symbols, and the number of OFDM symbols is time from a point in time at which a request for an inference operation for operating the intelligent model and function was received to a point in time at which a result of the inference is reported.

According to various embodiments of the present disclosure, a base station (BS) for identifying and managing an intelligent functionality or model in a wireless communication system includes a transceiver and a controller operably connected to the transceiver, wherein the controller transmits UE capability enquiry to user equipment (UE); receives UE capability information from the user equipment, in which the UE capability information includes inference time information; identifies intelligent functionality and model that the user equipment can support, on the basis of the UE capability enquiry and the UE capability information; and identifies performance of an intelligent model that the user equipment can perform on the basis of the inference time information.

An apparatus and a method according to various embodiment of the present disclosure use technologies of identifying intelligent functionality and model including inference time information and of managing a life cycle, thereby effectively performing intelligent model selection by referring to inference time for operating an intelligent technology operation for each user equipment. Accordingly, it is possible effectively apply an intelligent technology to a wireless communication system and improve transmission efficiency.

The effects of the disclosure are not limited to the effects described above and other effects can be clearly understood by those skilled in the art from the following description.

### BRIEF DESCRIPTION OF THE DRAWINGS

FIG. 1 is a conceptual view of an auto-encoder according to various embodiments of the present disclosure;

FIG. 2 is a conceptual view of a beam management process according to various embodiments of the present disclosure;

FIG. 3 is a conceptual view of intelligent positioning according to various embodiments of the present disclosure;

FIG. 4 is a view showing a first embodiment for identification of intelligent functionality and model including inference time information in accordance with an embodiment of the present disclosure;

FIG. 5 is a view showing a second embodiment for identification of intelligent functionality and model including inference time information in accordance with an embodiment of the present disclosure;

FIG. 6 is a view showing a third embodiment for identification of intelligent functionality and model including inference time information in accordance with an embodiment of the present disclosure;

FIG. 7 is a view showing a fourth embodiment for identification of intelligent functionality and model including inference time information in accordance with an embodiment of the present disclosure;

FIG. 8 is a view showing a process of obtaining inference time information in accordance with an embodiment of the present disclosure;

FIG. 9 is a view showing a model monitoring process including inference time information in accordance with an embodiment of the present disclosure;

FIG. 10 is a view showing a process of deactivating a model and switching models using inference time information in accordance with an embodiment of the present disclosure;

FIG. 11 is a view showing an example of model management using inference time information in accordance with an embodiment of the present disclosure;

FIG. 12 is a view showing an example of a CSI reporting process in accordance with an embodiment of the present disclosure;

FIG. 13 is a view showing an example of CSI computation time in accordance with an embodiment of the present disclosure;

FIG. 14 is a configuration view of a base station in a wireless communication system according to various embodiments of the disclosure; and

FIG. 15 is a view showing a configuration of user equipment in a wireless communication system according to various embodiments of the disclosure.

### DETAIL DESCRIPTION

Terminologies used in the present disclosure may be used only to describe specific embodiments without intention of limiting the range of other embodiments. Singular forms are intended to include plural forms unless the context clearly indicates otherwise. All terminologies used herein including technological or scientific terminologies may have the same meanings that are generally understood by those skilled in the art. Terminologies defined in general dictionaries of the terminologies used herein may be understood as having meanings the same as or similar to the meanings in the contexts and should not be construed as abnormally or exclusively formally meanings unless specifically defined herein. Depending on cases, even if terminologies are defined herein, they should not be construed as excluding the embodiments of the present disclosure.

Various embodiments of the present disclosure to be described hereafter are described through examples of hardware approaches. However, since various embodiments of the present disclosure include a technology that uses both hardware and software, various embodiments of the present disclosure do not exclude approaches based of software.

Further, in the specific description and claims of the present disclosure, “at least one of A, B, and C” may mean “only A”, “only B”, “only C”, or “any combination of A, B, and C”. Further, “at least one of A, B, or C” or “at least one of A, B, and/or C” may mean “at least one of A, B, and C”.

Hereafter, the present disclosure relates to an apparatus and method for intelligent model and functionality management considering inference time in a wireless communication system. In detail, the present disclosure describes a technology for using inference time information to recognize intelligent model and function and perform life cycle management in a wireless communication system.

In the following description, terms indicating signals, terms indicating channels, terms indicating control information, terms indicating network entities, terms indicating components of an apparatus, etc. are exemplified for the convenience of description. Accordingly, the present disclosure is not limited to the terms to be described hereafter and other terms having equivalent meanings may be used.

Further, various embodiments are described herein using the terms, which are used in some

communication standards (e.g., 3rd Generation Partnership Project (3GPP)), but they are only examples for description. Various embodiments of the present disclosure may be easily modified to be applied to other communication systems as well.

### Method of Improving Intelligent (AI/ML) Channel State Information Feedback

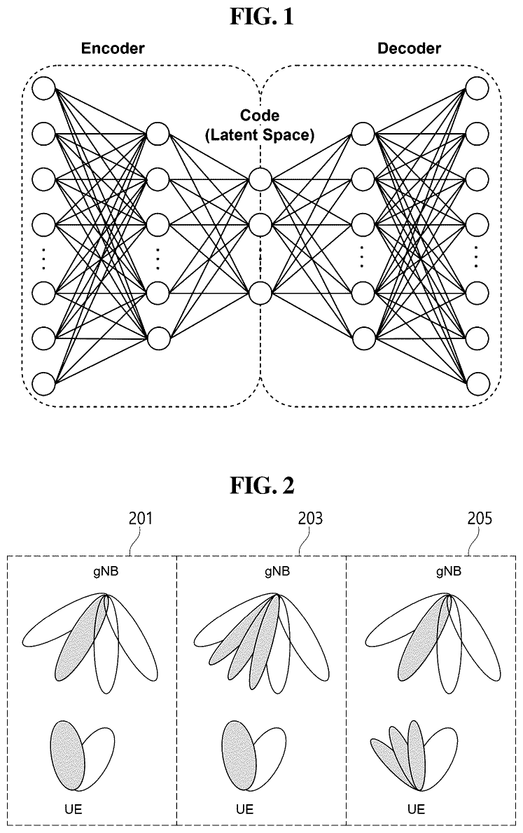

FIG. 1 is a conceptual view of an auto encoder according to various embodiments of the present disclosure.

Channel state information (CSI) feedback means that user equipment reports CSI to support a base station to be able to apply a transmission technique, such as Multiple Input Multiple Output (MIMO), or precoding in a wireless communication system. 5G NR standard defined by 3GPP supports feedback information such as a Channel Quality Indicator (CQI), a Precoding Matrix Indicator (PMI), and a Rank Indicator (RI) in relation to a channel information feedback method. Improvement of a CSI feedback technique is still under discussion to effectively support transmission technique such as Multi-user MIMO (MU-MIMO) in an NR system.

As one of research directions of integrating an intelligent technology to channel information feedback, a channel compression (CSI compression) technology for a plan for obtaining a compressed latent representation for a MIMO channel using an auto-encoder, which is one of intelligent techniques, is under discussion.

Referring to FIG. 1, an auto-encoder means a neural network structure simply copying input as output and is characterized by setting the number of neurons of a hidden layer between an encoder and a decoder smaller than that of an input layer such that data is compressed (or a dimension is reduced).

### Intelligent (AI/ML) Beam Management Method

FIG. 2 is a conceptual view of a beam management process according to various embodiments of the present disclosure.

As the frequency band that is used in wireless communication systems increases, millimeter wave (mmWave) bands (e.g., 30 GHz˜300 GHz) are used. When a high frequency band is used, the wavelength decreases and path loss become worse, whereby the range of a signal decreases. As a method for solving this problem, a plan for improving a range by generating a directional beam that directs the direction of a signal to a specific direction using an antenna technology is being used.

However, when such a directional beam is used, a process of selecting a base station beam (Tx beam) and a user equipment beam (Rx beam) that will show the optimum function of a base station and user equipment from a plurality of beams is required to ensure stable link performance. In order to select an optimum beam, it is required to obtain a measurement value for all of beams or to perform result measurement for a plurality of beam and select an optimum beam in accordance with the method of implementing a base station or user equipment. However, overhead is generated in the process of finding out an optimum beam and frequent overhead causes deterioration of performance and UE power consumption.

In order to overcome this problem, it is possible to introduce an intelligent technology into a beam management process. A beam management technology that uses an intelligent technology is a technology that maintains accuracy while reducing overhead that is used in existing beam measurement. In beam management based on an AI/ML intelligent technology, beam prediction that is a use case of predicting the beam of a resource that is not observed in a spatial domain or a time domain by applying an intelligent technology is under discussion.

FIG. 2 conceptually shows a process of selecting an optimum beam using various beam patterns in an intelligent beam management process.

The box 201 shows that when a single wide beam pattern is used, a base station and user equipment form a directional beam and perform communication.

The box 203 shows that a base station forms several narrow beam patterns and user equipment uses a wide beam pattern, whereby beam measurement is performed.

The box 205 shows that a base station and user equipment perform communication by finding out an optimum patter through beam prediction and selection processes both using several narrow beam patterns.

### Intelligent (AI/ML) Positioning Improvement Method

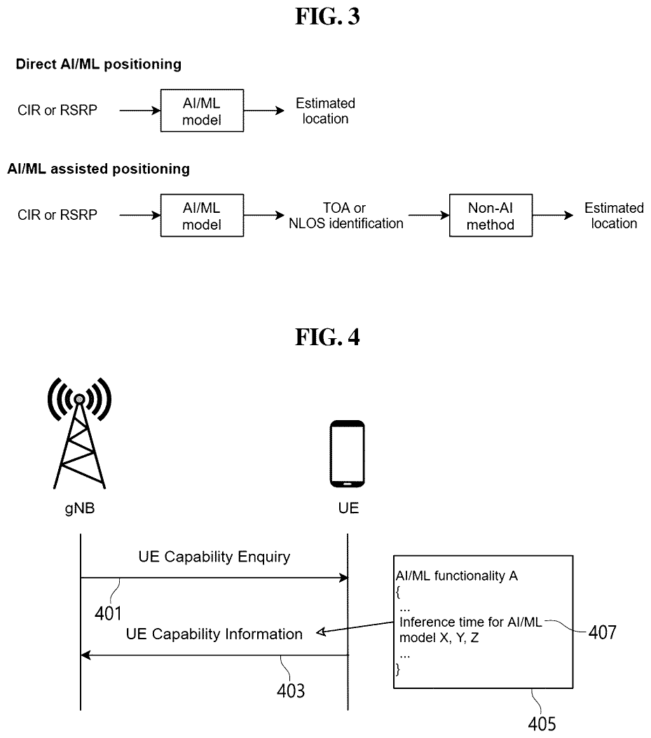

FIG. 3 is a conceptual view of intelligent positioning according to various embodiments of the present disclosure.

Referring to FIG. 3, positioning is a technique that measures the position of specific user equipment in a wireless communication system and the 5G NR standard defined by 3GPP supports the method of transmitting a Positioning Reference Signal (PRS) such that user equipment reports a

Reference Signal Time Difference (RSTD), and then apply a position measurement technique such as Observed Time Difference Of Arrival (OTDOA). Recently, the level of requirements for accuracy in indoor positioning is increasing and a technology of improving accuracy of measurement values for positioning by applying an intelligent technology in the point of view described above is under discussion. AI/ML assisted positioning that is a use case of increasing the accuracy of the positioning technique of the related art by applying an intelligent technology and direct AI/ML positioning that is a use case of directly estimating the position of user equipment by applying an intelligent technology are under discussion in intelligent technology-based positioning.

### Life Cycle Management of Intelligent (AI/ML) Model/Functionality

Since an intelligent technology is based on learning data, it has to be able to perform Life Cycle Management (hereafter, LCM) for creation, maintenance, etc. of an intelligent model that accompany variation of learning data. Accordingly, it is required to support LCM in a mobile communication system in order to apply a functionality based on an intelligent technology in a wireless communication system composed of a base station and/or user equipment, as in the use cases described above. In relation to this matter, 3GPP is discussing, as detailed stages of the LCM process described above, data collection, model training, model inference, model deployment, model activation, model deactivation, model selection, model monitoring, model transfer, etc. For example, a specific intelligent model in a wireless communication system may be created through data collection and model training, and then may undergoes model deployment and model activation processes, may operate through inference work using a model, and may be managed through a model monitoring process.

A method and an apparatus that use inference time information in a process of identifying and manage an intelligent model or functionality proposed in the present disclosure are described hereafter mainly in the point of view of downlink of a wireless mobile communication system composed of a base station and user equipment for the convenience of description, but a proposed plan of the present disclosure may be expansively applied to any wireless mobile communication system composed of a transmitter and a receiver.

Further, the present disclosure is described hereafter in terms of an intelligent channel feedback improvement method, an intelligent beam management method, and an intelligent positioning improvement method that are use cases that are under discussion under 5G NR standard by 3GPP, but proposal plans of the present disclosure may be expansively applied to other intelligent use cases as well.

### [Proposal 1]

The operation of an intelligent model in a wireless communication system is performed at a base station or user equipment. In particular, since user equipment has different hardware, even though a same model is operated, consumption of resources and time for actually performing the operation may be different. In general, computational complexity (e.g., FLOPs), the number of model parameters, a model storage (e.g., Mbytes), etc. are used to represent the complexity of an intelligent model. The computational complexity of a model means the number of times of operation for performing the operation of a specific model. The number of model parameters means the total sum of the variables of all layers constituting an intelligent model and the storage means the size for physically storing a corresponding model. The reason of providing the information with an intelligent model is for using the information to determine whether user equipment or a base station can support the operation of the intelligent model.

However, inference time of an intelligent model is not simply linearly proportioned to computational complexity, the number of model parameters, the model storage, etc. of an intelligent model described above, and may be changed in accordance with the structure of an intelligent model that is used. For example, even intelligent models having same computational complexity may have different inference time that is consumed, depending on the internal hierarchy. In general, inference time of an intelligent model is defined as time that is taken until output is generated after input of an intelligent model is given. Inference time may include not only time for which inference is actually performed in an intelligent model, but time that is consumed in pre-processing and/or post-processing.

A management process including identification and determination of use of an intelligent functionality or model is divisionally performed by a base station and user equipment. Available resources for hardware, particularly, user equipment that performs an intelligent model are limited and the configuration of hardware may be different in user equipment, so inference time of a same intelligent model may be different. It is required to determine whether selectable functionalities or models can operate in a currently given network situation using inference time information in an identification process including a process of determining an intelligent functionality or model that can be supported. Further, variation of inference time may not satisfy an operation time condition, depending on the load on user equipment, also in a life cycle management process of a selected model. Accordingly, inference time information of an intelligent functionality or model needs to be shared between user equipment and a base station.

[Proposal 1] described above may be applied with other proposal(s) of the present disclosure

unless they are in conflict with each other.

### Method of Identifying Intelligent Functionality/Model Including Inference Time Information

### [Proposal 2]

As one of methods in which user equipment and a base station share inference time information, it is possible to use inference time information in the process in which a base station and user equipment identify an intelligent model or functionality. It is required to be able to identify intelligent model and functionality that are supported in a network (Functionality identification or Model identification) before using intelligent model and functionality and managing a life cycle in a wireless communication system.

A base station can identify which intelligent models and functionalities user equipment can support, and can instruct activation, etc. of specific intelligent model and functionality in user equipment on the basis of the identified intelligent models and functionalities. The following two life cycle management directions are under discussion by 3GPP in relation to identification of intelligent functionalities and models described above.
Model-ID based LCM
Functionality based LCM

Model-ID based LCM may mean a life cycle management process in which a base station (or a base station-server) and user equipment (user equipment-server) share intelligent model information together with a model-ID in advance, and then the base station and the user equipment identify and manage an intelligent model on the basis of the model-ID. Functionality based LCM means a life cycle management process in which a base station (or a base station-server) and user equipment (user equipment-server) share functionality information for an intelligent functionality in advance and then the base station and the user equipment identify and manage an intelligent functionality using a functionality name or a functionality ID. However, two types of life cycle management may not be independently configured and may be configured and operated in a mixed type.

FIG. 4 is a view showing a first embodiment for identification of intelligent functionality and model including inference time information in accordance with an embodiment of the present disclosure.

Referring to FIG. 4, a base station and user equipment can identify intelligent functionality and model 405, which the user equipment can support, through UE capability enquiry and UE capability information processes 401 and 403.

In accordance with an embodiment, the UE capability information may include inference time information 407. In this case, the inference time information that the user equipment transmits is inference time information before an intelligent functionality or model to be used is determined, so inference time information about a general (or reference) model that the user equipment can perform may be included in UE capability information. For example, inference time information about a representative Resnet structure of a CNN model structure or a representative BERT structure of a transformer structure may be included. The base station receiving the inference time information can infer the degree of performance that user equipment generally (averagely) has through the inference time information. Accordingly, it is possible to estimate inference time that is taken by user equipment when using a specific intelligent functionality of model.

### [Proposal 3]

In the intelligent functionality or model identification process proposed in [Proposal 2], a base station can additionally perform an intelligent model identification process after receiving a UE capability information report from user equipment. The base station can transmit an intelligent functionality-related network configuration to the user equipment and the user equipment can report model information, which can be supported within the intelligent functionality-related configuration relating, to the base station.

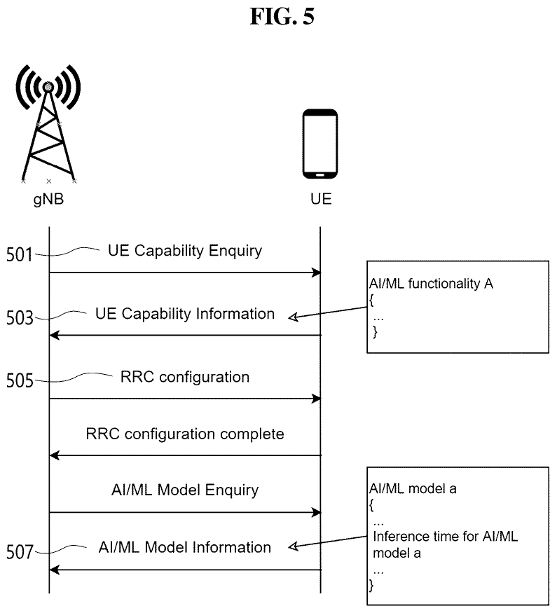

FIG. 5 is a view showing a second embodiment for identification of intelligent functionality and model including inference time information in accordance with an embodiment of the present disclosure.

Referring to FIG. 5, a base station and user equipment can first identify whether an intelligent functionality can be supported and the capability of the user equipment through UE capability enquiry and UE capability information reporting processes (501 and 503). In accordance with an embodiment, inference time information about a general model proposed in [Proposal 2] may be exchanged in the operations 501 and 503.

Thereafter, the base station can transmit an intelligent functionality-related network configuration through RRC signaling within a configuration that the user equipment can support (505).

The user equipment can transmit one or more pieces of intelligent model information, which can be supported within an intelligent functionality configuration received to an MAC control element (CE), to the base station. In accordance with an embodiment, the user equipment can transmit also inference time information when reporting model information. The inference time information may be inference time information that the user equipment currently infers or directly measured for a corresponding model that the user equipment can support.

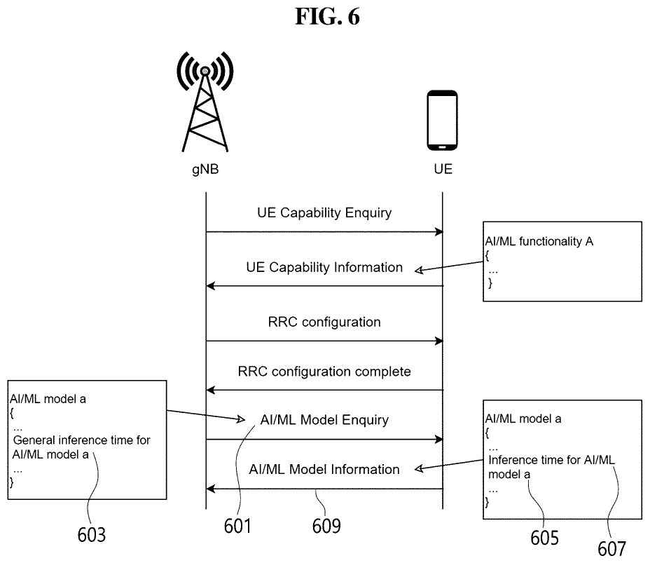

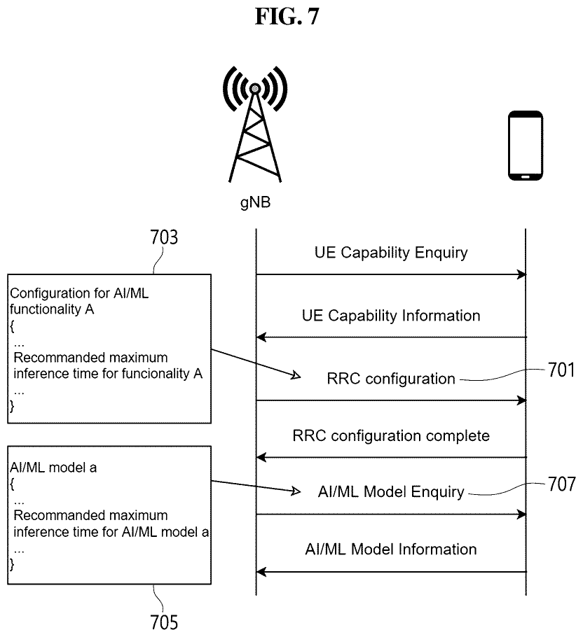

FIG. 6 is a view showing a third embodiment for identification of intelligent functionality and model including inference time information in accordance with an embodiment of the present disclosure.

Referring to FIG. 6, a base station can transmit inference time information 603 of a general user equipment about an intelligent model within a configuration that user equipment can support and the base station found out through a capability reporting process of the user equipment (601). General user equipment means user equipment having ordinary performance that a base station expects and may mean inference time information expected when the user equipment uses an intelligent model that is supported. Further, general user equipment does not mean only user equipment. For example, pieces of inference time information expected by a base station for user equipment having high performance and user equipment having low performance that are classified into several categories may be transmitted to the user equipment.

The user equipment refers to the transmitted inference time information and checks inference time information measured for the corresponding intelligent model. The user can report supportable intelligent model information 605 and inference time information 607 described above to the base station (609).

Thereafter, the base station can perform life cycle management on a specific model on the basis of the given information. The life cycle management process may include data collection model training, model inference operation, model deployment, model activation, model deactivation, model selection, model monitoring, model transfer, etc.

[Proposal 3] described above may be applied with other proposal(s) of the present disclosure unless they are in conflict with each other.

### [Proposal 4]

In the intelligent functionality and model identification process, a base station may include maximum inference time information 703 and 705 that is additionally recommended to an intelligent functionality-related network configuration (RRC configuration) (701). In accordance with an embodiment, the maximum inference time information may be set for each intelligent functionality 703 or each intelligent model 705 to which an intelligent technology is used.

Some operations do not matter even though a desired result is output within a longer time for each use case (or each intelligent functionality 703 or each intelligent model 705), so there may be room in inference time of an intelligent model. For example, in a use case of intelligent channel information feedback information, inference time may be determined in accordance with the cycles of reference signal (RS) transmission and CSI reporting set by a base station. Accordingly, the limit of the inference time of the intelligent functionality 703 or model 705 may be changed in accordance with a network configuration of a base station. As another example, in a use case of intelligent beam selection, inference time may be determined in accordance with a synchronization signal block (SSB) transmission cycle set by a base station. As described above, the range of inference time of a required intelligent functionality 703 or function 705 may be different in accordance with use cases and network situations.

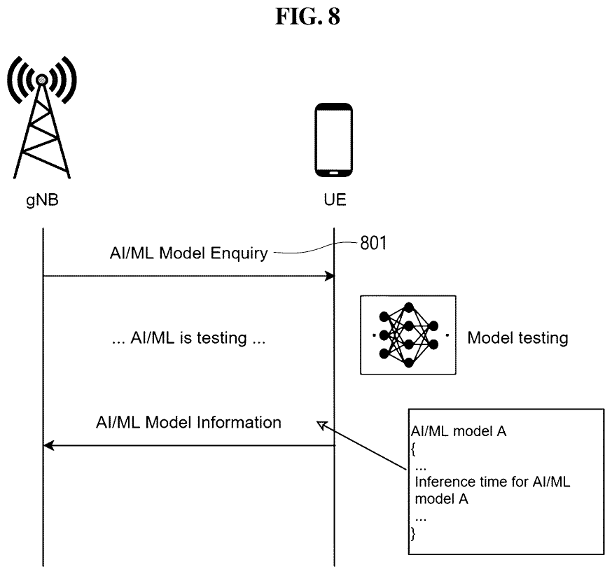

Transmission of maximum inference time information may be added to the intelligent technology or model identification process described in [Proposal 3]. As in FIG. 7, maximum inference time information for an intelligent functionality may be included in an RRC configuration process 701. Alternatively, maximum inference time information for an intelligent model may be transmitted when a base station requests intelligent model information from user equipment (707).

FIG. 7 is a view showing a fourth embodiment for identification of intelligent functionality and model including inference time information in accordance with an embodiment of the present disclosure.

Referring to FIG. 7, user equipment obtaining recommended maximum inference time information from a base station can use the maximum inference time information in the process of selecting a supportable intelligent model. For example, when inference time information of an intelligent model measured by itself is larger than maximum inference time information transmitted from a base station, the intelligent model can be excluded from supportable models.

[Proposal 4] described above may be applied with other proposal(s) of the present disclosure unless they are in conflict with each other.

### Plan for Managing Intelligent Functionality/Model Including Inference Time Information

### [Proposal 5]

Since inference time information necessarily depends on the performance of the hardware of user equipment that operates an intelligent model, it may be impossible to completely estimate inference time before a corresponding user equipment actually performs an inference operation through an intelligent model. Accordingly, a separate process in which a base station, if necessary, requests and receives inference time information of a specific intelligent model from user equipment should be defined separately from the intelligent functionality or model identification process described in the above proposals. The process in which a base station, if necessary, requests inference time information may be performed before an intelligent model is activated after the intelligent model is identified.

FIG. 8 is a view showing a process of obtaining inference time information in accordance with an embodiment of the present disclosure.

Referring to FIG. 8, a base station can transmit an intelligent model for which the base station wants to obtain inference time information to user equipment (801). The user equipment can transmit inference time information obtained by performing an operation for measuring inference time rather than an actual operation of the intelligent model to the base station.

The base station can determine whether to activate the intelligent model using the inference time information obtained through the operation 801.

[Proposal 5] may be applied with other proposal(s) of the present disclosure unless they are in conflict with each other.

### [Proposal 6]

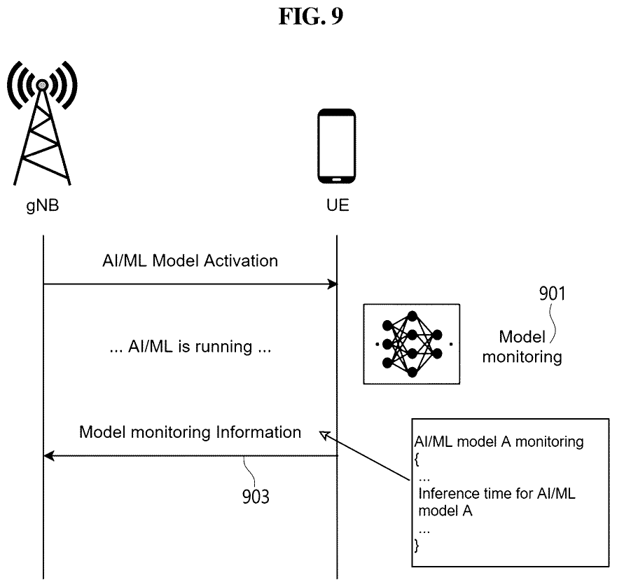

FIG. 9 is a view showing a model monitoring process including inference time information in accordance with an embodiment of the present disclosure.

An intelligent model for which life cycle management is being performed through intelligent model and functionality identification can continuously perform a model monitoring or performance monitoring operation that manages the information of performing and measures performance of the intelligent model (901). In accordance with an embodiment, key performance indicators (KPI) of model monitoring (or performance monitoring) may include inference time. Since inference time depends on the performance of hardware that operates an intelligent model, user equipment can measure inference time consumed when an inference operation is performed by actually driving a corresponding intelligent model, and can report the inference time to a base station through a monitoring process (903). The base station can use the transmitted inference time information for inference time statistics of user equipment and may use it for other life cycle managements.

In accordance with an embodiment, the model monitoring process 901 can be performed at a base station or user equipment, depending on use cases. When a model monitoring process is performed at a base station, user equipment has to transmit measured inference time information to the base station.

In accordance with another embodiment, when a model monitoring process is performed only at user equipment, inference time information may not be directly transmitted to a base station.

[Proposal 6] described above may be applied with other proposal(s) of the present disclosure unless they are in conflict with each other.

### [Proposal 7]

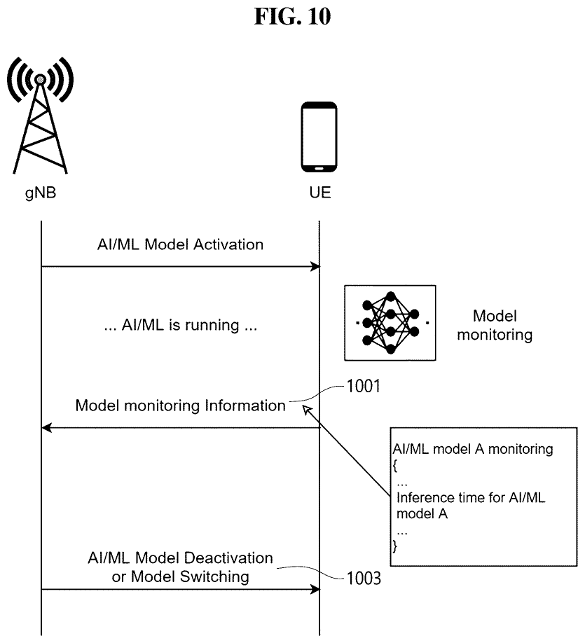

FIG. 10 is a view showing a process of deactivating a model and switching models using inference time information in accordance with an embodiment of the present disclosure.

Referring to FIG. 10, when inference time information exceeding the maximum inference time proposed in [Proposal 4] is continuously reported through the model monitoring process in [Proposal 6] described above, a base station or user equipment may deactivate use of a corresponding intelligent functionality or intelligent model or may switching models (1003).

An example when a proposed operation is performed is as following drawing. A base station can receive model monitoring information including inference time information (1001) and then can perform an intelligent functionality or model management operation.

In accordance with an embodiment, when user equipment performs a model monitoring operation, it is possible to transmit or trigger only the information saying that a currently operating model violates maximum inference time to a base station. The base station can perform a management operation on the basis of the information of violating maximum inference time.

In accordance with another embodiment, the user equipment can request the base station to change network configuration information for keeping operating the currently operating model rather than the information of violating maximum inference time.

[Proposal 7] described above may be applied with other proposal(s) of the present disclosure unless they are in conflict with each other.

### [Proposal 8]

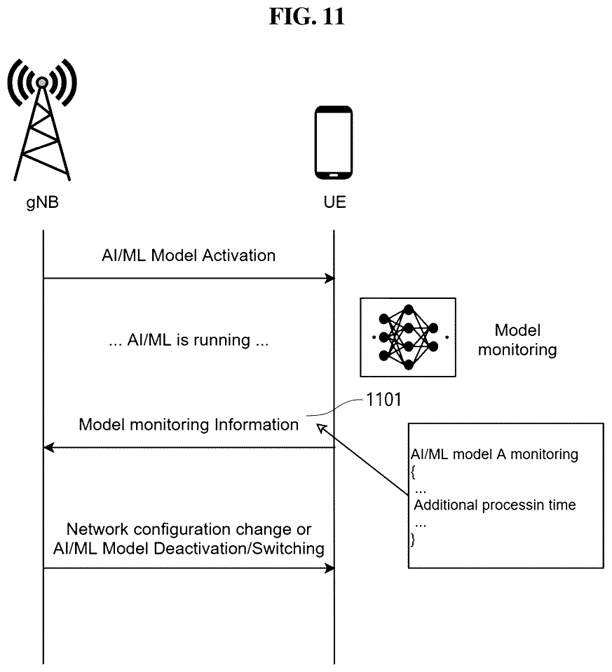

FIG. 11 is a view showing an example of model management using inference time information in accordance with an embodiment of the present disclosure.

It may be different to actually implement the operation of a base station precisely computing maximum inference time information that is provided by the base station. This is because it is difficult for a base station to obtain information about processing time accompanying operation of user equipment other than inference time of an intelligent model. For example, considering a use case of intelligent channel compression (CSI compression), there may be a need for a process of estimating a wireless channel and computing an eigenvector before using an intelligent model. The processing time that is taken in this process may depend on implementation of user equipment. Accordingly, it is possible to accurately obtain processing time for all operations of user equipment including inference time when only the user equipment uses a current intelligent model. When the processing time is insufficient due to the inference time of the intelligent model on the basis of the accurately obtained processing time, the user equipment can compute additional processing time for using the current intelligent model. The user equipment, if necessary, transmits the computed additional processing time to a base station (1101). The base station, if necessary, can change a network configuration or perform a life cycle management operation on the current model to secure additional processing time on the basis of corresponding information.

[Proposal 8] described above may be applied with other proposal(s) of the present disclosure unless they are in conflict with each other.

### [Proposal 9]

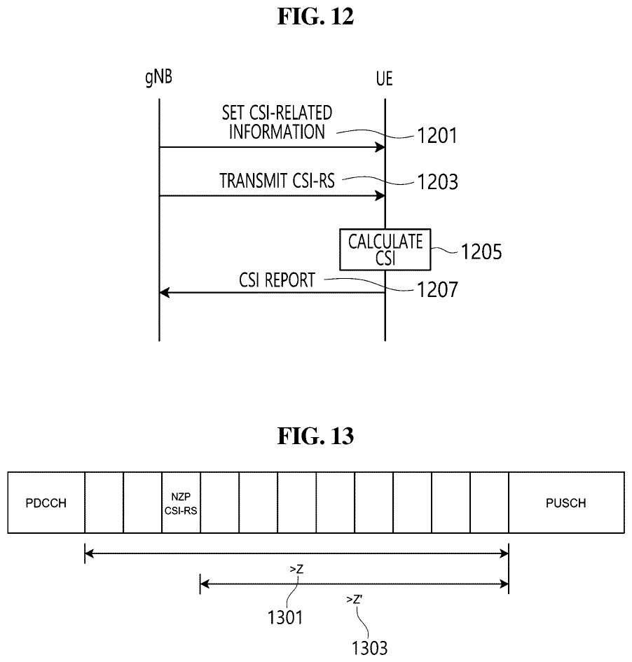

FIG. 12 is a view showing an example of a CSI reporting process in accordance with an embodiment of the present disclosure.

In order to operate an intelligent model, a process in which user equipment transmits pieces of information that are required for input of the intelligent model or is created by output to a base station may be required.

In a 5G NR system, CSI reporting was generally used in a corresponding reporting process. A channel information (CSI) reporting process by a general user equipment is as in FIG. 12.

Referring to FIG. 12, a base station can set CSI-related information including CSI-RS resource configuration information in user equipment (1201).

The base station can transmit the configured CSI-RS (1203).

The user equipment receiving the CSI-RS can create a report by computing necessary CSI in accordance with configuration of the CSI.

The user equipment can transmit the created CSI report to the base station (1207).

In the operation 1201 to the operation 1207, time for the user equipment to compute and configure information for a CSI reporting.

FIG. 13 is a view showing an example of a CSI computation time in accordance with an embodiment of the present disclosure.

In NR, time for computing and configuring information for CSI reporting is determined as CSI computation time. Time from a PDCCH triggering CSI reporting to a PUSCH at which user equipment reports including CSI information is represented by the number Z of OFDM symbols (1301), and time for a CSI-RS signal used for CSI reporting computation to a PUSCH at which user equipment reports including CSI information is represented by the number Z′ of OFDM symbols. Z and Z′ mean minimum time for user equipment to compute a corresponding repot and may be differently set in accordance with the type of CSI reporting.

In accordance with an embodiment, when an interval set for CSI reporting is shorter than Z or Z′ set in advance by user equipment, the user equipment may not perform reporting or may transmit a report with a corresponding position filled with certain bits.

As one method in which user equipment and a base station share inference time for the intelligent functionality or model described above, a method similar to CSI computation time may be used. User equipment can compute minimum inference time required for the process of an intelligent functionality. Further, the user equipment can calculate necessary time on the basis of the point in time at which a request for an inference operation was received or the point in time an RS signal for the inference operation was transmitted, such as CSI computation time, and can inform a base station of the time in advance.

The base station performs an actual inference operation of an intelligent functionality or model using the minimum inference time information reported from the user equipment. For example, in CIS feedback improvement and beam management that are representative use case of the intelligent technology, an inference operation can be performed on the basis of a CSI reporting operation. When an intelligent model for intelligent beam management exists in user equipment, values corresponding to output of the intelligent model should be transmitted from the user equipment to a base station through an inference process. The CSI reporting process described above is used in this process. Since an intelligent CSI compression case is operated on the basis of an existing CSI feedback framework, an output result of an encoder existing in user equipment is transmitted to a base station using a CSI reporting process in an inference process. In an intelligent CSI prediction case as well, an intelligent model positioned at user equipment transmits future CSI information to a base station using a CSI reporting process. Accordingly, in this case, user equipment transmits necessary minimum inference time information to a base station, similar to the method of setting CSI computation time, and the minimum inference time information can be used in an inference operation of an intelligent model. [Proposal 9] described above may be applied with other proposal(s) of the present disclosure unless they are in conflict with each other.

A plurality of proposal plans described above is plans that are related to each other rather than independent. For example, it is possible to configure a new proposal plan by coupling/combining a technical component of any one proposal plan with a technical component of another proposal plan, and such as new proposal plan is also included in various embodiments of the present disclosure. As described above, the following embodiment can be configured by coupling/combining a technical component selected from any one proposal plan with a technical component selected from another proposal plan.

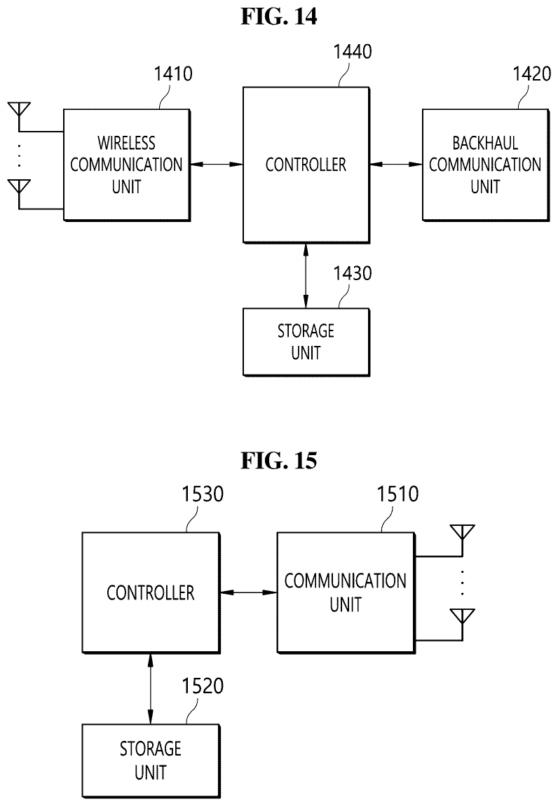

FIG. 14 is a configuration view of a base station in a wireless communication system according to various embodiments of the disclosure. The configuration exemplified in FIG. 14 may be understood as the configuration of a base station. Terms ‘ . . . unit’, ‘ . . . er’ used hereafter mean the unit for processing at least one function or operation and may be implemented by hardware, software, or a combination of hardware and software.

Referring to FIG. 14, a base station may include a wireless communication unit 1410, a backhaul communication unit 1420, a storage unit 1430, and a controller 1440.

The wireless communication unit 1410 can transmit and receive a wireless signal through a wireless channel. For example, the communication unit 1410 can perform a conversion function among baseband signals and bit strings in accordance with the physical layer specification of a system. Further, the wireless communication unit 1410 can generate complex symbols by encoding and modulating a transmission bit string when transmitting data. When receiving data, the wireless communication unit 1410 can recover a received bit string by demodulating and decoding a baseband signal.

The wireless communication unit 1410 can up-convert baseband signals into radio frequency (RF) band signals and then transmit the converted signals through an antenna, and can down-convert RF band signals received through the antenna into baseband signals. To this end, the wireless communication unit 1410 may include a transmission filter, a reception filter, an amplifier, a mixer, an oscillator, a digital to analog converter (DAC), an analog to digital converter (ADC), etc.

The wireless communication unit 1410 may include several transmission and reception paths and may include at least one antenna array composed of several antenna elements.

In terms of hardware, the wireless communication unit 1410 may include a digital unit and an analog unit, in which the analog unit may include a plurality of sub-units, depending on the operation power, operation frequency, etc. The digital unit may be implemented as at least one processor (e.g., a digital signal processor (DSP).

The wireless communication unit 1410 can transmit and receive a wireless signal, as described above. Accordingly, the wireless communication unit 210 may be entirely or partially referred to as a ‘transmitter’, a ‘receiver’, or a ‘transceiver’. Further, in the following description, transmission and reception that are performed through wireless channels may include performing the above-mentioned processing by means of the wireless communication unit 1410.

The backhaul communication unit 1420 can provide an interface for communication with other nodes in a network. That is, the backhaul communication unit 1420 converts bit stings that are transmitted from the base station to another node, for example, another connection node, another base station, an upper node, and a core network, into physical signals, and converts physical signals received from another node into bit strings.

The storage unit 1430 can store data such as fundamental programs, applications, and setting information for operation of the base station. The storage unit 1430 may be a volatile memory, a nonvolatile memory, or a combination of a volatile memory and a nonvolatile memory. Further, the storage unit 1430 can provide stored data in response to a request from the controller 1440. The controller 1440 can control general operations of the base station. For example, the

controller 1440 can transmit and receive signals through the wireless communication unit 1410 or the backhaul communication unit 1420. Further, the controller 1440 can record and read data on and from the storage unit 1430. Further, the controller 1440 can perform the functions of a protocol stack required by communication standards.

To this end, the controller 1440 may include at least one processor.

In accordance with various embodiments of the disclosure, the controller 1440 can perform control to perform operations according to various embodiments that are performed by the base station in FIGS. 1 to 13.

FIG. 15 is a view showing a configuration of user equipment in a wireless communication system according to various embodiments of the disclosure. The configuration exemplified in FIG. 15 may be understood as the configuration of user equipment. Terms ‘ . . . unit’, ‘ . . . er’ used hereafter mean the unit for processing at least one function or operation and may be implemented by hardware, software, or a combination of hardware and software.

Referring to FIG. 15, user equipment may include a communication unit 1510, a storage unit 1520, and a controller 1530.

The communication unit 1510 can perform functions for transmitting/receiving signals through wireless channels. For example, the communication unit 1510 can perform a conversion function among baseband signals and bit strings in accordance with the physical layer specification of a system. For example, the communication unit 1510 can generate complex symbols by encoding and modulating a transmission bit string when transmitting data. When receiving data, the communication unit 1510 can recover a received bit string by demodulating and decoding a baseband signal. Further, the communication unit 1510 can up-convert baseband signals into RF band signals and then transmit the converted signals through an antenna, and can down-convert RF band signals received through the antenna into baseband signals. For example, the communication unit 1510 may include a transmission filter, a reception filter, an amplifier, a mixer, an oscillator, a DAC, an ADC, etc.

Further, the communication unit 1510 may include several transmission/reception paths. Further, the communication unit 1510 may include at least one antenna array composed of several antenna elements. In terms of hardware, the communication unit 1510 may be composed of a digital circuit and an analog circuit (for example, a radio frequency integrated circuit (RFIC)). In this case, the digital circuit and the analog circuit may be implemented in one package. Further, the communication unit 1510 may include several RF chains. Further, the communication unit 1510 can perform beamforming.

The communication unit 1510 transmits and receives signals, as described above. Accordingly, the communication unit 1510 may be entirely or partially referred to as a ‘transmitter’, a ‘receiver’, or a ‘transceiver’. Further, transmission and reception that are performed through wireless channels may be used as meanings that include the above-mentioned processing performed by the communication unit 1510.

The storage unit 1520 can store data such as fundamental programs, applications, and setting information for operation of the user equipment. The storage unit 1520 may be a volatile memory, a nonvolatile memory, or a combination of a volatile memory and a nonvolatile memory. Further, the storage unit 1520 can provide stored data in response to a request from the controller 1530.

The controller 1530 can control general operations of the user equipment. For example, the controller 1530 can transmit and receive signals through the communication unit 1510. Further, the controller 1530 can record and read data on and from the storage unit 1520. The controller 1530 can perform the functions of a protocol stack required by communication standards. To this end, the controller 1530 may include at least one processor or microprocessor, or may be a part of a processor. A portion of the communication unit 1510 and the controller 1530 may be referred to as a communication processor (CP).

In accordance with various embodiments, the controller 1530 can perform control to perform operations according to various embodiments that are performed by the user equipment in FIGS. 1 to 13.

Methods according to the claims or the embodiments described in the specification may be implemented in the type of hardware, software, or a combination of software and hardware.

When they are implemented in software, a computer-readable storage medium that stores one

or more programs (software modules) may be provided. The one or more programs stored in the computer-readable storage medium are configured for execution by one or more processors in an electronic device. The one or more programs include instructions for the electronic device to perform the methods according to the claims of the disclosure or embodiments described in the specification.

Such programs (software modules, software) may be stored in a nonvolatile memory including a random access memory and a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs), or another type of optical storage device, and a magnetic cassette. Alternatively, they may be stored in a memory configured by combining some or all of the devices. Each configuration memory may be included as several pieces.

The programs may be stored in an attachable storage device that can be accessed through a communication network such as the internet, an intranet, a Local Area Network (LAN), a Wide Area Network (WAN), or a Storage Area Network (SAN), or a network configured by combining them. The storage device can access a device that performs embodiments of the disclosure through an external port. A separate storage device in a communication network can access a device that performs the embodiments of the disclosure.

In the detailed embodiment of the disclosure described above, the components included in the disclosure were described in singular forms or plural forms, depending on the proposed detailed embodiments. However, the singular or plural expressions were appropriately selected in the proposed situations for the convenience of description and the disclosure is not limited to the singular or plural components. Further, even if components are described in a plural form, they may be singular components, or even if components are described in a singular form, they may be plural components.

Although detailed embodiments were described above, various modifications are possible without departing from the scope of the disclosure. Accordingly, the range of the disclosure is not limited to the embodiments and should be defined by not only the range of the claims described below, but also equivalents to the range of the claims.

What is claimed is:

1. A method of operating user equipment (UE) for identifying and managing an intelligent (AI/ML) functionality or model in a wireless communication system, the method comprising:
receiving UE capability enquiry from a base station (BS); and
transmitting UE capability information to the base station,
wherein the UE capability information includes inference time information,
wherein the UE capability information comprises information used to identify at least one of the intelligent functionalities or models that the UE capable of supporting, and
wherein the inference time information comprises information used to identify the performance of the intelligent model that the UE is capable of performing.

2. The method of claim 1, wherein the method further comprises receiving, from the base station, instructions to activate a specific intelligent functionality or model determined based on performance of an intelligent model that the user equipment can perform.

3. The method of claim 1, wherein the inference time information includes inference time information about a general model that the user equipment can perform.

4. The method of claim 1, further comprising transmitting an intelligent functionality-related network configuration (RRC configuration) to the base station,
wherein the network configuration includes maximum inference time information that is recommended for each intelligent functionality, each intelligent model, or each use case.

5. A method of operating a base station (BS) for identifying and managing an intelligent functionality or model in a wireless communication system, the method comprising:
transmitting UE capability enquiry to user equipment (UE); and
receiving UE capability information from the user equipment, wherein the UE capability information includes inference time information, and
identifying intelligent functionality and model that the user equipment can support, on the basis of at least one of the UE capability enquiry, or the UE capability information; and
identifying performance of an intelligent model that the user equipment can perform, on the basis of the inference time information.

6. The method of claim 5, further comprising transmitting, to the user equipment (UE), instruction to activate a specific intelligent functionality or model on the basis of performance of an intelligent model that the UE can perform.

7. The method of claim 5, wherein the inference time information includes inference time information about a general model that the user equipment can perform.

8. The method of claim 5, further comprising receiving an intelligent functionality-related network configuration (RRC configuration) from the user equipment,
wherein the network configuration includes maximum inference time information that is recommended for each intelligent functionality, each intelligent model, or each use case.

9. A method of operating user equipment (UE) for managing an operation of intelligent model and functionality in a wireless communication system, the method comprising:
computing minimum required inference time for operating the intelligent model and functionality; and
transmitting the inference time to a base station (BS),
wherein the inference time is represented by the number of orthogonal frequency division multiplexing (OFDM) symbols, and
wherein the number of OFDM symbols is time from a point in time at which a request for an inference operation for operating the intelligent model and function was received to a point in time at which a result of the inference is reported.

10. The method of claim 9, further comprising transmitting the inference time information to the base station in advance.
